(19) United States
(12) Patent Application Publication
(10) Pub. No.: US 2011/0205445 A1
(43) Pub. Date: Aug. 25, 2011

(54) TELEVISION CONTROL SYSTEM AND METHOD THEREOF

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/817,152

(22) Filed: Jun. 16, 2010

(30) Foreign Application Priority Data
Feb. 24, 2010 (TW) 99105349

(51) Int. Cl. H04N 5/44

(52) U.S. Cl. 348/734; 348/E05.096

(57) ABSTRACT

A television (TV) control system and method controls a TV set to perform functions remotely. The system includes a hand-held electronic device and a bridge device. The hand-held electronic device includes an accelerometer and a signal generation module. The accelerometer senses a moving direction of the hand-held electronic device when a user operates the hand-held electronic device, and analyzes the moving direction to generate a direction analysis result. The signal generation module generates a remote control signal according to the direction analysis result. The bridge device receives the remote control signal transmitted from the hand-held electronic device, and controls the TV set to perform functions according to the remote control signal.

### BACKGROUND

1. Technical Field

Embodiments of the present disclosure relate generally to systems and methods for remotely controlling electronic devices, and more particularly to a system and method for remotely controlling a television.

2. Description of Related Art

Television (TV) sets which are controlled by a remote control are well known in the art. For example, a user can control a TV set to switch from one channel to another channel by pressing buttons of the remote control. A conventional remote control includes a frame to support a plurality of mechanical function buttons that execute predetermined functions. The more functions the remote control has, the more buttons are disposed on the remote control. Therefore, the frame should be designed as large as possible to hold the function buttons. However, it is inconvenient for the user to operate remote controls with ever increasing function buttons on the remote control to operate the TV set.

### BRIEF DESCRIPTION OF THE DRAWINGS

FIG. 1 is a schematic diagram of one embodiment of a television (TV) control system.

FIG. 2 is a flowchart of one embodiment of a method for remotely controlling a TV using a system such as, for example, that of FIG. 1.

FIG. 3 shows a schematic diagram illustrating one example of a hand-held electronic device capable of being swung in multiple directions.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

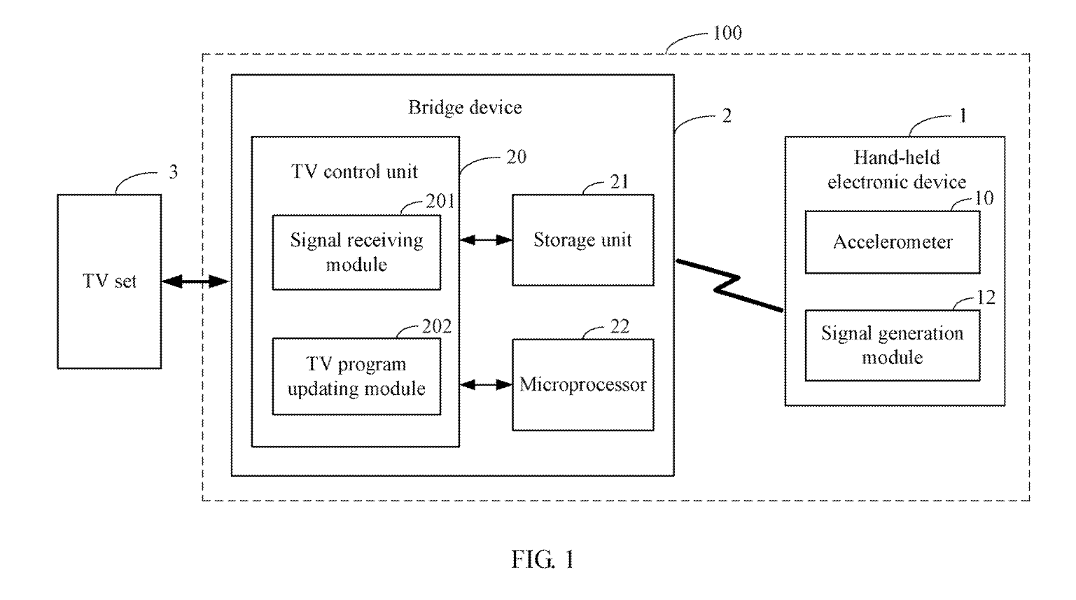

FIG. 1 is a schematic diagram of one embodiment of a television (TV) control system 100 including a hand-held electronic device 1, and a bridge device 2. In the embodiment, the system 100 can be used to remotely control a TV set 3 to perform various functions, such as switching from one TV channel to another TV channel, for example. The hand-held electronic device 1 communicates with the bridge device 2 by a wireless connection, such as radio frequency (RF), infrared ray, or BLUETOOTH, for example. The bridge device 2 connects to the TV set 3 through one or more electrical connections. The hand-held electronic device 1 includes an accelerometer 10, and a signal generation module 12. The bridge device 2 includes a TV control unit 20, a storage unit 21, and at least one microprocessor 22. It should be apparent that FIG. 1 shows only one example of an architecture for the system 100 and may include more or fewer components than shown, or a different configuration of the various components in other embodiments. In one embodiment, the hand-held electronic device 1 may be a remote control, a mobile phone, a personal digital assistant (PDA), or a portable game machine. The bridge device 2 may be a digital connector for controlling the TV set 3, or a computing device such as a PC computer or a notebook.

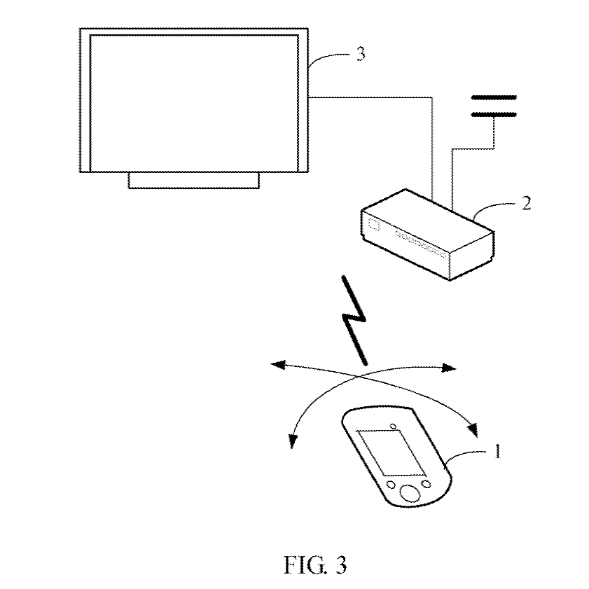

The accelerometer 10 is operable to sense a moving direction of the hand-held electronic device 1 when a user operates the hand-held electronic device 1, and analyze the moving direction to generate a direction analysis result. Operation of the hand-held electronic device 1, in one embodiment, can be done by swinging the hand-held electronic device in a left, right, up, or down direction, or a combination thereof. FIG. 3 shows a schematic diagram illustrating one example of the hand-held electronic device 1 capable of being swung in multiple directions.

In one embodiment, the signal generation module 12 may be hardware consisting of one or more integrated circuit chips, or a software program consisting of one or more computerized instructions. The signal generation module 12 is operable to generate a remote control signal according to the direction analysis result, and transmit the remote control signal to the bridge device 2 by the wireless connection. In one embodiment, the signal generation module 12 generates a first signal for controlling a current TV channel to go forward when the hand-held electronic device 1 is moved towards the left direction, a second signal for controlling a current TV channel to go back when the hand-held electronic device 1 is moved towards the right direction, a third signal for activating a TV program menu of the TV set 3 when the hand-held electronic device 1 is moved towards the up direction, and a fourth signal for terminating the TV program menu when the hand-held electronic device 1 is moved towards the down direction.

The TV control unit 20 may include a plurality of functional modules including one or more computerized instructions that are stored in the storage unit 21. The storage unit 21 may be an internal storage device, such as a random access memory (RAM) for temporary storage of information and/or a read only memory (ROM) for permanent storage of information. The storage unit 21 may also be an external storage device, such as a hard disk, a storage card, or a data storage medium. The microprocessor 22 runs various software modules stored in the storage unit 21 to control the TV set 3 to perform various functions.

In one embodiment, the TV control unit 20 includes a TV control module 201, and a TV program updating module 202. One or more computerized codes of the function modules may be stored in the storage unit 21 and executed by the microprocessor 22. In general, the word “module,” as used herein, refers to logic embodied in hardware or firmware, or to a collection of software instructions, written in a programming language. The software instructions in the modules may be embedded in firmware, such as an erasable programmable read only memory (EPROM). The modules described herein may be implemented as either software and/or hardware modules and may be stored in any type of computer-readable medium or other storage device.

The TV control module 201 is operable to receive the remote control signal transmitted from the hand-held electronic device 1, and control the TV set 3 to perform a corresponding function according to the remote control signal. For example, if the remote control signal is the first signal, the TV control module 201 controls the current TV channel to go forward one channel. If the remote control signal is the second signal, the TV control module 201 controls the current TV channel to go back one channel. If the remote control signal is the third signal, the TV control module 201 controls the TV set 3 to drive the TV program menu for the user to choose a TV program from the TV program menu. If the remote control signal is the fourth signal, the TV control module 201 controls the TV set 3 to terminate the TV program menu.

The TV program updating module 202 is operable to download TV program names from a TV network system to update the TV program menu, and store the updated TV program menu into the storage unit 21. In one embodiment, the TV network system provides different TV programs by a broadcast television provider, such as a national broadcasting company (NBC), or Canadian broadcasting corporation (CBC), for example. A user may search the TV program menu for a favorite program, and switches the current channel to the channel of the favorite program by swinging the hand-held electronic device 1 in a corresponding direction.

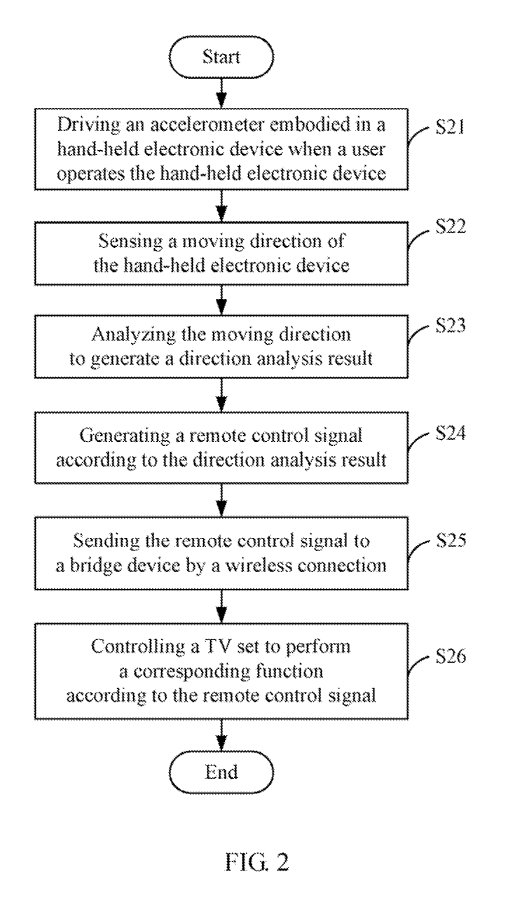

FIG. 2 is a flowchart of one embodiment of a method for remotely controlling a TV using a system such as, for example, that of FIG. 1. In the embodiment, the TV control method can remotely control the TV set 3 to perform various functions, such as switching from one TV channel to another TV channel, for example. Depending on the embodiment, additional blocks may be added, others removed, and the ordering of the blocks may be changed.

In block S21, the hand-held electronic device 1 drives the accelerometer 10 when a user operates the hand-held electronic device 1. As mentioned above, the accelerometer 10 is embodied in the hand-held electronic device 1. As illustrated in FIG. 3, operation of the hand-held electronic device 1, in one embodiment, can be done by swinging the hand-held electronic device in a left, right, up, or down direction, or a combination thereof.

In block S22, the accelerometer 10 senses the moving direction of the hand-held electronic device 1. In block S23, the accelerometer 10 analyzes the moving direction to generate a direction analysis result.

In block S24, the signal generation module 12 generates a remote control signal according to the direction analysis result. In one example with respect to FIG. 3, the signal generation module 12 generates a first signal for controlling a current TV channel to go forward one channel when the hand-held electronic device 1 is moved towards the left direction, a second signal for controlling a current TV channel to go back one channel when the hand-held electronic device 1 is moved towards the right direction, a third signal for activating a TV program menu of the TV set 3 when the hand-held electronic device 1 is moved towards the up direction, and a fourth signal for terminating the TV program menu when the hand-held electronic device 1 is moved towards the down direction.

In block S25, the signal generation module 12 transmits the remote control signal to the bridge device 2 by the wireless connection. In block S26, the TV control module 201 receives the remote control signal transmitted from the hand-held electronic device 1, and controls the TV set 3 to perform a corresponding function according to the remote control signal. For example, if the remote control signal is the first signal, the TV control module 201 controls the current TV channel to go forward one channel. If the remote control signal is the second signal, the TV control module 201 controls the current TV channel to go back one channel. If the remote control signal is the third signal, the TV control module 201 controls the TV set 3 to drive the TV program menu for the user to choose a TV program from the TV program menu. If the remote control signal is the fourth signal, the TV control module 201 controls the TV set 3 to terminate the TV program menu.

In some embodiments, the TV control method may further update TV program names in the TV program menu in real time. In details, the TV program updating module 202 downloads TV program names from the TV network system to update the TV program menu, and stores the updated TV program menu to the storage unit 21. Thereby, a user can search the TV program menu to choose a favorite program, and can switch from the current channel to the channel of the favorite program by swinging the hand-held electronic device 1 in a corresponding direction.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A hand-held electronic device, comprising:
an accelerometer operable to sense a moving direction of the hand-held electronic device, and analyze the moving direction to generate a direction analysis result; and
a signal generation module operable to generate a remote control signal according to the direction analysis result, and transmit the remote control signal to a bridge device for controlling a TV set to perform functions according to the remote control signal.

2. The hand-held electronic device according to claim 1, wherein the bridge device comprises:
a TV control module operable to receive the remote control signal transmitted from the hand-held electronic device, and control the TV set to perform functions according to the remote control signal.

3. The hand-held electronic device according to claim 1, wherein the bridge device comprises:
a TV program updating module operable to download TV program names from a TV network system to update a TV program menu of the TV set, and store the TV program menu to a storage unit of the bridge device.

4. The hand-held electronic device according to claim 1, wherein the hand-held electronic device is selected from the group consisting of a remote controller, a mobile phone, a personal digital assistant (PDA), and a portable game machine.

5. The hand-held electronic device according to claim 1, wherein the signal generation module generates a first signal for controlling a current TV channel to go forward one channel on condition that the moving direction is a left direction.

6. The hand-held electronic device according to claim 1, wherein the signal generation module generates a second signal for controlling a current TV channel to go back one channel on condition that the moving direction is a right direction.

7. The hand-held electronic device according to claim 1, wherein the signal generation module generates a third signal for activating a TV program menu of the TV set on condition that the moving direction is an up direction.

8. The hand-held electronic device according to claim 1, wherein the signal generation module generates a fourth signal for terminating a TV program menu of the TV set on condition that the moving direction is a down direction.

9. A method for remotely controlling a television (TV) set, the method comprising:
driving an accelerometer embodied in a hand-held electronic device when a user operates the hand-held electronic device;
sensing a moving direction of the hand-held electronic device by using the accelerometer;
analyzing the moving direction to generate a direction analysis result;
generating a remote control signal according to the direction analysis result;
transmitting the remote control signal to a bridge device connected to the hand-held electronic device by a wireless connection; and
controlling the TV set to perform functions according to the remote control signal.

10. The method according to claim 9, further comprising:
downloading TV program names from a TV network system to update a TV program menu of the TV set; and
storing the TV program menu to a storage unit of the bridge device.

11. The method according to claim 9, wherein the hand-held electronic device is selected from the group consisting of a remote controller, a mobile phone, a personal digital assistant (PDA), and a portable game machine.

12. The method according to claim 9, wherein the generation of a remote control signal according to the direction analysis result comprises:
generating a first signal for controlling a current TV channel to go forward one channel on condition that the moving direction is a left direction;
generating a second signal for controlling a current TV channel to go back one channel on condition that the moving direction is a right direction;
generating a third signal for activating a TV program menu of the TV set on condition that the moving direction is an up direction; and
generating a fourth signal for terminating the TV program menu on condition that the moving direction is a down direction.

13. A storage medium having stored thereon instructions that, when executed by a hand-held electronic device, causes the electronic device to perform a method for remotely controlling a television (TV) set, the method comprising:
driving an accelerometer embodied in the hand-held electronic device when a user operates the hand-held electronic device;
sensing a moving direction of the hand-held electronic device by using the accelerometer;
analyzing the moving direction to generate a direction analysis result;
generating a remote control signal according to the direction analysis result;
transmitting the remote control signal to a bridge device connected to the hand-held electronic device by a wireless connection; and
controlling the TV set to perform functions according to the remote control signal.

14. The storage medium according to claim 13, wherein the method further comprises:
downloading TV program names from a TV network system to update a TV program menu of the TV set; and
storing the TV program menu to a storage unit of the bridge device.

15. The storage medium according to claim 13, wherein the hand-held electronic device is selected from the group consisting of a remote controller, a mobile phone, a personal digital assistant (PDA), and a portable game machine.

16. The storage medium according to claim 13, wherein the generation of a remote control signal according to the direction analysis result comprises:
generating a first signal for controlling a current TV channel to go forward on condition that the moving direction is a left direction;
generating a second signal for controlling a current TV channel to go back on condition that the moving direction is a right direction;
generating a third signal for activating a TV program menu of the TV set on condition that the moving direction is an up direction; and
generating a fourth signal for terminating the TV program menu on condition that the moving direction is a down direction.
